(19) United States
(12) Patent Application Publication
(10) Pub. No.: US 2006/0225322 A1
(43) Pub. Date: Oct. 12, 2006

(54) Repositionable indexing tab device

(75) Inventors: Timothy J. O'Leary, White Bear Lake, MN (US); Gregory J. Anderson, Stillwater, MN (US); Ashish K. Khandpur, Lake Elmo, MN (US); Eser Ozdeger Donovan, Prescott, WI (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/099,801

(22) Filed: Apr. 6, 2005

(51) Int. Cl. B42F 21/00

(52) U.S. Cl. 40/359

(57) ABSTRACT

A document management article, e.g., file folder, comprising a track member that comprises a multiplicity of parallel, narrowly spaced, elastically deformable ribs. Repositionable index tabs may be attached thereto.

### FIELD

This invention relates to document management articles, e.g., file folders, file and notebook dividers, report covers, notebooks, binders, media binders, and the like, with repositionable index tabs.

### BACKGROUND

Despite advances in the computer industry, there is still a need to retain hard copy records, documents, floppy disks and other media, in an orderly fashion. Many items such as receipts, faxes, drafts, documents, newspaper clippings, etc. are obtained only in hardcopy form. It is often desired to retain these hard copies in an organized or systematic fashion. For example, filing cabinets and desk drawers contain hanging file folders with index tabs that are often coded in an alphabetical or numerical fashion to allow for easy retrieval of individual files. However, there remains a problem when the index tabs are obscured by tabs from other files in close proximity and finding and organizing files becomes a cumbersome task.

One solution is to use repositionable index tabs. In one embodiment, index tabs can be removed from one position and placed into another more desirable position on the folder, secured by slots in the edge of the folder. Unfortunately, it is inconvenient to reposition the index tabs in such folders, e.g., when additional files are interspersed among the prior files. In later embodiments, the index tabs are seated in and can be positioned anywhere along tracks, sometimes referred to as rails or slide borders, that extend across the width of the folder. The problem still remains in that the sliding tab does not stay in a fixed position and can easily be jostled to another position when the files are being handled. Illustrative examples of such sliding index tabs are described in JP10217664, EP122380, and US2003/0126779.

There is a need in the art for a sliding index tab device that avoids the drawbacks of the conventional devices heretofore described.

### SUMMARY

The present invention addresses the problem for displacement of sliding index tabs by providing a track member along which an index tab can be easily moved back and forth as desired. In another aspect, the invention also secures the index tab in desired place preventing it from accidentally sliding out of position when the file is jostled or handled. This feature also permits easy removal and reinsertion of the tab as desired. The invention may be used with a variety of document management articles, e.g., file folders, file and notebook dividers, and the like.

Briefly summarizing, an illustrative file folder of the invention comprises a first side panel having outer and inner edges; a second side panel having outer and inner edges; a binding edge interposed between the inner edges of the first and second side panels for coupling the first and second side panels; and a track member arranged in parallel to the outer edge of the first side panel and comprising two or more narrowly spaced, elastically deformable ribs arranged substantially parallel to the outer edge. A tab member can be repositionably engaged with the track member.

The present invention also provides a kit for making document management articles of the invention.

### BRIEF DESCRIPTION OF DRAWINGS

The invention will be further described with reference to the following idealized drawings which are not to scale.

FIG. 1 is a plan view of the inside of an illustrative file folder of the invention fully opened;

FIG. 2 is a side view of the folder in FIG. 1, shown closed;

FIG. 3 is a perspective broken view of an illustrative track member of the invention;

FIG. 4 is a cross section view of the track member of FIG. 3;

FIGS. 5a-5d schematically show portions of a different illustrative track member of the invention as it is interengaged with an illustrative tab member of the invention; and

FIG. 6 is a side view of an illustrative embodiment of a rib useful in some track members and tab members of the invention.

### DETAILED DESCRIPTION OF ILLUSTRATIVE EMBODIMENTS

For convenience the invention will be explained in detail with reference to a file folder. It will be understood, however, that the invention may be similarly used with other document management articles such as notebook covers, report covers, binders, media binders, dividers for use in files, notebooks, reports, binders, etc.

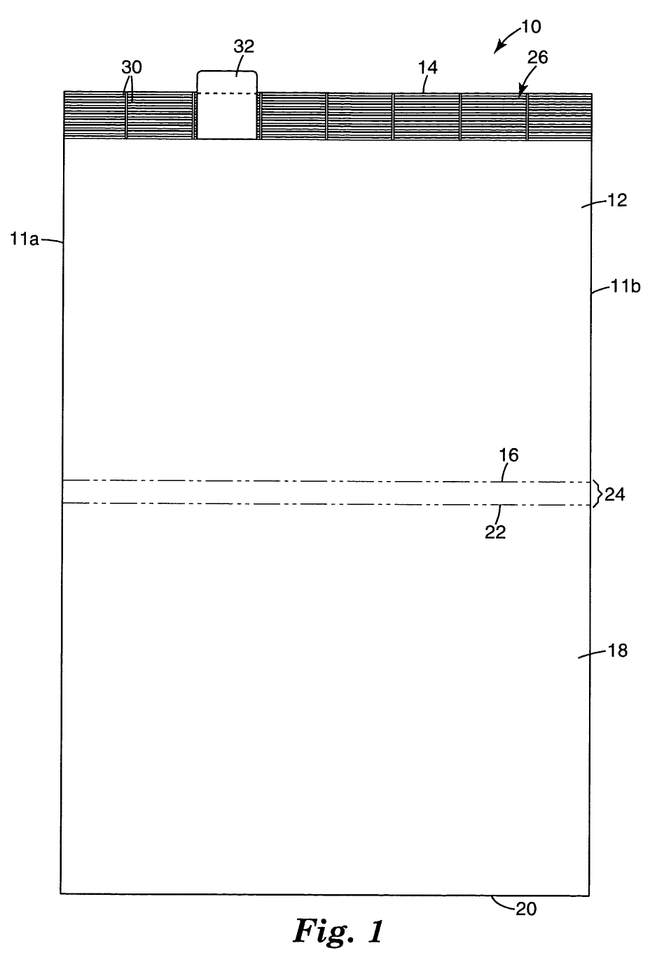

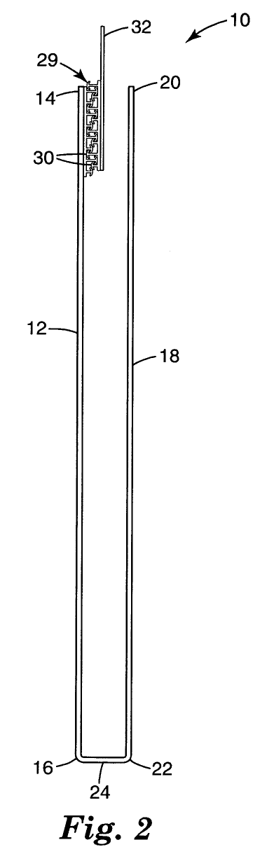

As illustrated in FIGS. 1 and 2, a file folder 10 of the invention, comprises a first side panel 12 having outer 14 and inner edges 16; a second side panel 18 having outer 20 and inner edges 22; a binding edge 24 interposed between the inner edges of the first and second side panels for coupling the first and second side panels; and a track member 26 arranged in parallel to the outer edge 14 of the side panel 12 and comprising two or more ribs 30 arranged substantially parallel to the outer edge 14. The first side panel 12 has side edges 11a and 11b. A tab member 32 can be repositionably engaged with the track member 26 in accordance with the invention, the tab member having a portion that repositionably engages with the track member and a portion upon which desired indicia may be displayed. The track member 26 is preferably immediately adjacent (as shown) to outer edge 14 but may be merely near outer edge 14 if desired.

By “repositionably engaged” it is meant that the tab member will remain in stable, and presumably desired, position on the track member until a significant repositioning force is applied to move the tab member to another location on the track member or even to disengage it from the track member and remove it therefrom entirely.

The track member 26 preferably extends substantially all the way to side edges 11a and 11b, but may be shorter if desired (or even longer than the width of side panel 12 though this may tend to reduce the convenient handling, use, and storage of such embodiments of the invention). Track member 26 is shown on the inside surface of side panel 12, but may alternatively be on the outside surface of the side panel if desired.

File folders of the invention can be any known suitable material, e.g., plastic, paper, pasteboard, cardboard, or metal. They can be made in any desired size, e.g., a standard size such letter size, legal size, A4, etc. or a specialty size, dependent in large part upon the file cabinets and other file storage devices which are being used.

The binding edge 24 may consist of a single fold, or in the case of larger capacity files, multiple folds, as is known in the art of file folders. FIGS. 1 and 2 illustrate a file folder with a two fold binding edge. In some embodiments, binder edge 24 may be a reinforced region or made of a different material than are first side panel 12 and second side panel 18. If desired, first side panel 12 and second side panel 18 may each be made of different materials.

In one illustrative embodiment, the track member comprises a multiplicity of parallel, narrowly spaced, elastically deformable ribs projecting from a base sheet. The ribs comprise a stem portion attached to and substantially upright from the base sheet and at least one flange attached to each side of the stem portion and spaced from the base sheet. The cross-sectional profile formed by the ribs is substantially uniform over the length of the ribs. Similar structures are disclosed as self-mating, reclosable fasteners in U.S. Pat. No. 6,367,128 (Galkiewicz et al.) which is incorporated herein in its entirety.

As illustrated in FIG. 3, an illustrative track member 26 of the invention comprises a multiplicity of ribs 30 attached to and projecting upwardly from the base sheet 32. The ribs 30 are substantially parallel to one another and are substantially equally spaced apart a transverse distance 34. Each rib comprises a stem portion 36 and a flange 38.

In some embodiments, the track member will comprise a layer of adhesive 40 to secure the track member to the file folder as desired. A suitable adhesive may be readily selected dependent upon the nature of the track member, nature of the file folder, desired method of attaching the track member to the file folder, and whether permanent or temporary mounting is desired. Illustrative examples of suitable adhesives include pressure-sensitive adhesives, hot melt adhesives, repositionable adhesives, etc. The track member may be attached to the side panel by other means (not shown) if desired, e.g., mechanical means such as sewing or stapling through the base sheet 32.

In one illustrative embodiment, the ribs 30 are substantially continuous over their length. In other embodiments, however, the ribs are interrupted, as by cutting after extrusion and optionally stretching the base sheet to form a space between the adjacent ends of the interrupted ribs. In addition, interruptions prepared by pressure on an extruded web, for example, with a hot wheel, can make the base sheet thicker in the area of the interruption (thickened with the material of the ribs which has flowed under pressure of the hot wheel). These thickened regions may be useful to provide a barrier to relative sliding movement between the track member and a mating tab member, as discussed further below. Such interruptions can be conveniently formed by contact of the ribbed surface of an extruded web with projections on a heated wheel, whereby longitudinally spaced portions of the ribbed structure are periodically pressed down and accumulate as a raised structure or dam. The dam has a greater height or thickness than the base sheet. The height of the dam is sufficient that when the track member is mated with a tab member, at least the tallest ribs of the other tab member will engage the dam and impede relative sliding movement of the tab member along the track member. A dam may be provided on only one side or end of the track member to limit movement in one direction, or a dam may be provided on both ends of the track member nearest the side edges 11a and 11b of side panel 12. Instead of a dam taking the form of structure raised above the base sheet, rib deformations such as widening of the rib by pressing outer portions of the rib toward, but not all the way into contact with, the base sheet may be used, or cutting a thermoplastic rib with a hot knife as discussed above can be used.

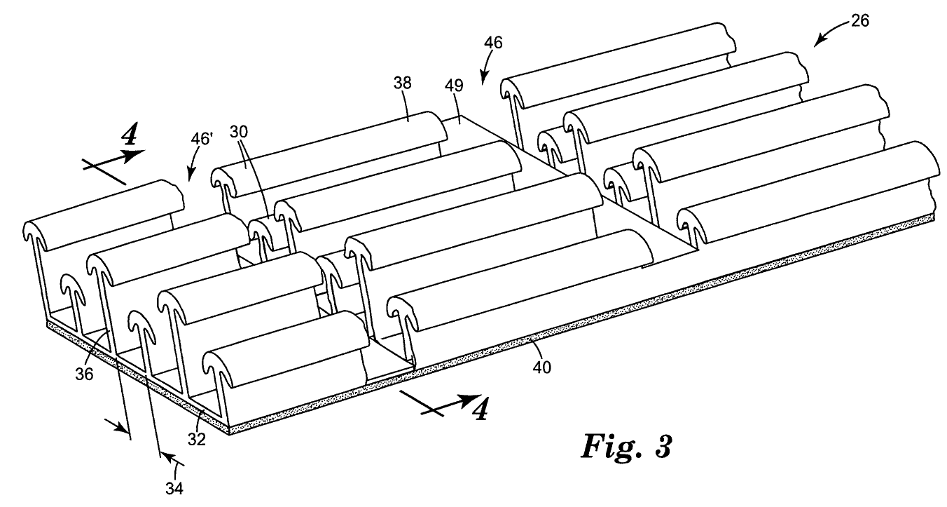

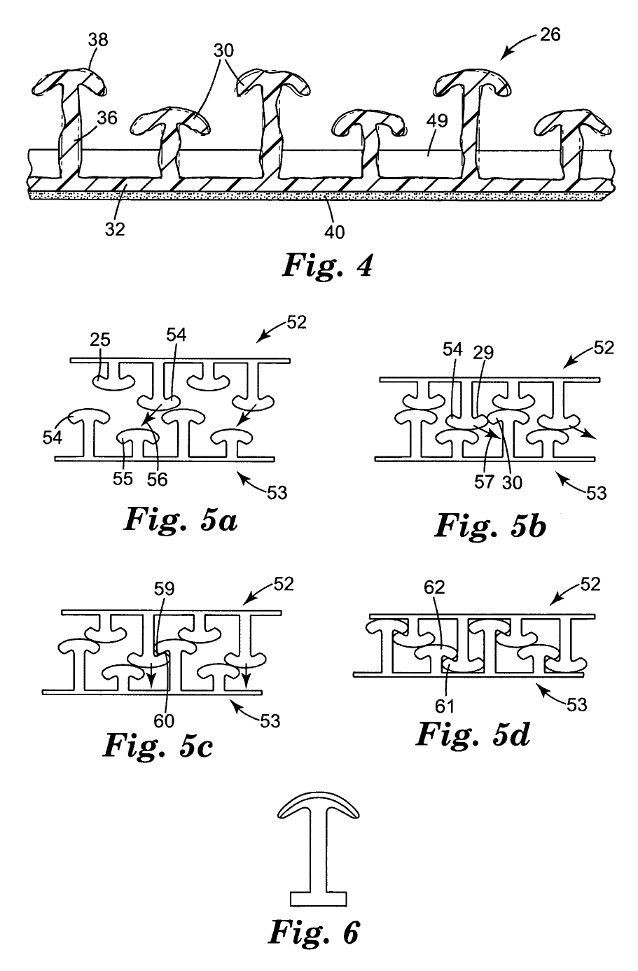

Openings or interruptions in the ribs can provide points at which tab members can be more readily, as desired, removed from the file folder. The openings also permit tabs to be readily mated to the file folder by bending the file folder and track member so as to widen the opening, thereby permitting the tab member to slide past. Such an embodiment is illustrated in FIGS. 3 and 4 wherein track member 26 comprises ribs 30 with openings 46 and 46′ and base sheet 32 with thickened regions 49. Alternatively, the ribs may be cut with a hot knife or similar means to yield openings 46′. As shown in FIG. 4, the shape or profile of the ends of ribs 30 can be disrupted by forming openings 46′ when the ribs are made of a thermoplastic material. Such disruptions to the profile of the ribs can provide stops or “click action” points to assist with desired arrangement of tab member(s) on the file folder.

The interruptions permit the tab member to be moved along the track member in an indexed fashion, e.g., with stops or clicks, facilitating positioning it in a registered fashion. This facilitates organization of a set of files with the tab members positioned as desired. The interruptions are typically oriented substantially perpendicular or transverse to the longitudinal axis of the ribs. Preferably the interruptions are spaced at uniform distances apart to facilitate desired positioning of tab members. For example, in some embodiments, the interruptions will be spaced apart at a distance equal to the width of the tab members or slightly more. In this way, when multiple file folders of this configuration are placed together and index tabs engaged therein in accordance with the invention, the tabs on successive folders can be easily arranged in off-set fashion to reduce blocking by other tab members.

The interruptions may be of any desired width. In some embodiments, interruptions having an average width of from about 1/32 to ⅛ of an inch will be useful, though wider or narrower widths may be used in accordance with the invention. If the interruptions are too narrow, it may be relatively more difficult to remove tab members from the track member. If the interruptions are too wide, tab members may tend to separate from the track member when it is merely desired to reposition the tab member to a different location on the track member to which it is repositionably engaged.

In some embodiments, the height of the ribs will be substantially uniform and in other embodiments, the ribs will be of alternating high and low height as shown in FIGS. 3 and 4. It will be apparent to those skilled in the art that other embodiments may be used in accordance with the invention.

FIGS. 5a-5d schematically illustrate an illustrative track member of the invention 53, and show it undergoing interengagement with a hook 52 having similar rib construction. The track member 53 includes ribs of different height, with tall ribs 54 alternating one-by-one with shorter ribs 55. This repeated deviation from the profile of a full population of identical (e.g., equally tall) symmetrical ribs facilitates a lower force interengagement of the track member and hook. As shown in FIG. 5a, the taller ribs 54 contact one another first during interengagement of the track member and hook; and as shown by the arrow 56, the heads of the taller ribs tend to move into the gap caused by the shortness of the adjacent ribs 55. This self-aligning of the ribs and attached members helps assure an easy and effective interengagement when attaching a hook to a file folder of the invention. Upon further pressure on the members, as shown in FIGS. 5b and 5c, the taller ribs are directed by their contact with the adjacent shorter ribs (see the arrow 57 of FIG. 5b) into a position where the right flange 59 of a tall rib 54 of the hook slides under the left flange 60 of a tall rib 54 of the track member (“right” and “left” in this paragraph refer to positions in FIG. 5). Upon further pressure, as shown in FIG. 5d, the left flange 61 of a tall rib 54 of the hook moves under the right flange 62 of a short rib 55 of the track member. The described movement of the head portion of the tall ribs 54 during interengagement occurs unimpeded because there is no structure of equal height adjacent the tall ribs. The lowest-force interengagement is obtained when tall and short ribs alternate with one another one-by-one; somewhat higher interengagement forces can be obtained if a lesser number of short ribs is used so that some tall ribs are adjacent to one another.

A further desirable performance characteristic of the track and tab members illustrated in FIGS. 5a-5d is that the force required to achieve interengagement is of a serial or two-stage nature. That is, a first exercise of force is required to achieve the first stage of interengagement illustrated in FIGS. 5b and 5c, and a second, subsequent exercise of force is required to achieve the full interengagement illustrated in FIG. 5d. Because of this serial or two-stage exercise of force, the maximum force required at any one time is reduced and interengagement is made easier. Also, a track member and hook or optional tab member pair of this type may have two different degrees of interengagement, allowing one lower force, perhaps temporary interengagement, and a higher-force, perhaps more lasting interengagement.

The difference in height between the tall rib 54 and short rib 55 may vary. Typically the height difference should not be so great as to prevent a significant number of tall and short ribs from having complete engagement. The term “complete engagement” means generally involving the illustrated movement of the flanges of the tall ribs on one of the track member or tab member pair underneath the short ribs of the opposed member of the pair. The desired ratio of rib heights will be affected by a number of parameters such as material and thickness of the rib portions and shape of the ribs. For example, the taller ribs may be about one-fourth to three-fourths again taller than the shorter ribs. In some embodiments of the invention, the tall ribs are on the order of one-and-one-half times the height of the short ribs.

The rib in FIG. 6 is a representative coextruded rib, which in this case includes two different materials, a first material constituting the principal portion of the rib and a second material constituting a top portion of the rib. More than two materials may be extruded and may constitute different portions of a rib or base sheet. For example, the base sheet might comprise one material, e.g., for flexibility or suppleness, and the ribs comprise a different material, e.g., a stiffer material. Or the stem portion of a rib may comprise one material, e.g., having flexibility, elasticity, or fatigue-resistant properties desired for repeated flexing, and the head portion, i.e., the top portion of the rib including the flanges, may comprise a different material, e.g., a stiffer, non-flexing material.

In one embodiment, the height of a stem portion is preferably greater than the width of a flange attached to the stem portion. The result (assuming the same thickness and composition for stem and flange) is that the stem portion will tend to flex in preference to flexure of the flanges under the pressure placed on the ribs during interengagement with the ribs of an opposed tab member. Bending stiffness is generally proportional to W(T/L)³ for a long beam of length L, width W, and thickness T, when bending occurs in the thickness direction. Because the stem is typically longer than the arms, flexing occurs more easily in the stem if the flanges and stem have similar thicknesses and composition. The ease of flexing in both stem and flanges can be controlled by choice of structure, dimensions and modulus of elasticity of the material of the stem and of the flanges.

Track members and tab members of the invention may be made from a variety of materials but most commonly are made from polymeric materials, using generally any polymer that can be melt processed. Homopolymers, copolymers and blends of polymers are useful, and may contain a variety of additives. Inorganic materials such as metals may also be used. The composition is chosen to provide desired bending characteristics, including usually an elastic bending movement of the stem of the rib in a direction lateral to the length of the rib and little if any bending of the flanges during engagement and disengagement. Generally an elastic modulus of from 10³ MPa to 10⁷ MPa for the composition of the base sheet and ribs including any additives is satisfactory but this may change depending on the application.

Suitable thermoplastic polymers include, for example, polyolefins such as polypropylene or polyethylene, polystyrene, polycarbonate, polymethyl methacrylate, ethylene vinyl acetate copolymers, acrylate-modified ethylene vinyl acetate polymers, ethylene acrylic acid copolymers, nylon, polyvinylchloride, and engineering polymers such as polyketones or polymethylpentanes. Elastomers include, for example, natural or synthetic rubber, styrene block copolymers containing isoprene, butadiene, or ethylene (butylene) blocks, metallocene-catalyzed polyolefins, polyurethanes, and polydiorganosiloxanes. Mixtures of the polymers and/or elastomers may also be used.

Suitable additives include, for example, plasticizers, tackifiers, fillers, colorants, ultraviolet light stabilizers, antioxidants, processing aids (urethanes, silicones, fluoropolymers, etc.), low-coefficient-of-friction materials (silicones), conductive fillers to give the track member and tab member each a level of conductivity, pigments, and combinations thereof, as desired. Generally, additives can be present in amounts up to 50 percent by weight of the composition depending on the application.

Track members and tab members of the invention can be formed by extruding a polymeric web through a die having an opening cut, for example, by electron discharge machining.

The shape of the die is designed to generate a web with a desired cross-sectional shape or profile. The web is generally quenched after leaving the die by pulling it through a quenching material such as water. A wetting agent may be required in the quenching medium to assure good wetting of the whole surface of the extruded web, including spaces between ribs. The extruded web may be further processed, e.g., by cutting extruded ribs and stretching the web to form interruptions in the ribs or by forming structure to limit relative movement between paired track member and tab member. Track members and tab members are then formed, generally by cutting and slitting the extruded web.

In some embodiments, track members will be made via extrusion. Track members may also be made in other ways, for example, by injection molding or casting. Also, a ribbed track member structure of the invention can be incorporated into a larger sheet from which a file folder or other document management article is made. The track member or tab member structure can be incorporated into the larger article in various ways, e.g., by inserting an already prepared ribbed portion into a mold and molding the rest of the article around the ribbed portion; or by configuring a mold surface with mold structure shaped to form a ribbed structure of the invention. When ribbed structure of the invention is incorporated into a larger article, the term “base sheet” herein includes the structure of the article into which the ribbed structure is incorporated.

As previously stated, the body of a ribbed structure of the invention may include multiple layers, generally of different composition. Such multiple layers can be provided by coextrusion techniques (as described, for example, in published PCT Appln. No. WO 99/17630, published Apr. 15, 1999), which may involve passing different melt streams from different extruders into a multiple-manifold die or a multiple-layer feed block and a film die. The individual streams merge in the feed block and enter the die as a layered stack that flows out into layered sheets as the material leaves the die. The die is patterned so as to form the ribbed configuration of the track member and tab member. A track member of the invention thus may have a base sheet of one composition and ribs of a different composition. Or a portion of the ribs, e.g., the top edge-portion of the rib, may have a different composition from other portions of the rib. For example, the top portion of the rib may include a composition that forms a lower friction surface than the rest of the rib.

In some embodiments, the tab member will have a portion that repositionably engages with the track member, e.g., a multiplicity of ribs as discussed above and a second portion on which desired indicia may be displayed. In some embodiments, the second portion may be a flat portion that is receptive to writing with at least one of pen, pencil, or marker. In some embodiments, the tab member will be adapted for attachment of desired indicia thereto, for instance a portion shaped to receive indicia-bearing members, such as adhesive-backed flags or stickers, clip on indicators, etc. As will be understood by those with skill in the art, the present invention may be adapted to permit use of a wide range of indicia.

In some embodiments, the track member can be used as a site to secure an accessory member to the track member. For instance, an attachment member comprising a multiplicity of ribs as discussed above with regard to the tab member which has another portion adapted to secure writing instruments, computer disks, etc. could be used in accordance with the invention.

The ribbed nature of track members and tab members of the invention provides a desired alignment feature to the articles.

What is claimed is:

1. A document management article comprising a side panel and a track member said track member comprises a multiplicity of parallel, narrowly spaced, elastically deformable ribs projecting from a base sheet; the ribs comprising a stem portion attached to and substantially upright from the base sheet and at least one flange attached to each side of the stem portion and spaced from the base sheet; the cross-sectional profile formed by the ribs being substantially uniform over the length of the ribs.

2. The article of claim 1 wherein said article is selected from the group consisting of file folder, notebook cover, report cover, binder, file divider, and notebook divider.

3. The article of claim 1 wherein said article is a file folder, comprising a first side panel having outer and inner edges; a second side panel having outer and inner edges; a binding edge interposed between said inner edges of said first and second side panels for coupling said first and second side panels; and a track member arranged in parallel to the outer edge of said first side panel and comprising two or more ribs arranged substantially parallel to said outer edge.

4. The file folder of claim 4 wherein said track member extends along the major portion of said top edge.

5. The article of claim 1 wherein said track member comprises a multiplicity of parallel, narrowly spaced, elastically deformable ribs projecting from a base sheet; the ribs comprising a stem portion attached to and substantially upright from the base sheet and at least one flange attached to each side of the stem portion and spaced from the base sheet; the cross-sectional profile formed by the ribs being substantially uniform over the length of the ribs.

6. The article of claim 5 wherein at least some of said ribs are interrupted over their length.

7. The article of claim 6 wherein substantially all of said ribs are interrupted in the direction transverse to the longitudinal axis said ribs to limit the relative sliding motion between said track member and a tab member engaged with said track member.

8. The article of claim 1 further comprising a tab member repositionably engaged with said track member wherein said tab member can be moved along said track member.

9. The file folder of claim 8 wherein said tab member comprises two or more ribs that are arranged substantially parallel to the ribs of said track member, said tab member ribs being mechanically engaged with said ribs of said track member, said tab member being repositionable along said track member.

10. A kit for providing a repositionable indexing tab on a file folder, said kit comprising at least one track member comprising a multiplicity of parallel, narrowly spaced, elastically deformable ribs projecting from a base sheet; the ribs comprising a stem portion attached to and substantially upright from the base sheet and at least one flange attached to each side of the stem portion and spaced from the base sheet; the cross-sectional profile formed by the ribs being substantially uniform over the length of the ribs and at least one tab member that can repositionably engage with said ribs of said track member.
